(19) United States
(12) Patent Application Publication
(10) Pub. No.: US 2005/0000864 A1
(43) Pub. Date: Jan. 6, 2005

(54) Method and apparatus for cleaning coal

(76) Inventor: Warren E. Kelm, Malvern, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/808,006

(22) Filed: Mar. 23, 2004

Related U.S. Application Data
(60) Provisional application No. 60/457,254, filed on Mar. 24, 2003.

(51) Int. Cl. B03B 1/00; B07B 1/00; B03C 1/00; B07B 1/28

(52) U.S. Cl. 209/309; 209/225

(57) ABSTRACT

A system for removing clean coal from raw coal without the use of water includes a vibratory separator which receives the raw coal and a supply of magnetic particles. The magnetic particles form a fluidized bed which floats the clean coal from the debris contained in the raw coal and removes the clean coal by a scraper plate. A mixture of debris and magnetic particles which remains after the clean coal is removed is passed by a revolving magnetic separator which removes the magnetic particles from the debris and from the clean coal, and returns the particles for reuse with another batch of raw coal. The magnetic separator includes a rotating drum having a non-magnetic outer surface and an interior magnet which forms a magnetic field adjacent a portion of the drum surface which temporarily attracts the magnetic particles which fall from the drum surface as that portion of the drum surface and collected particles pass beyond the adjacent magnet.

### CROSS REFERENCE TO RELATED APPLICATION

This application is a standard utility based upon provisional patent application Ser. No. 60/457,254, filed Mar. 24, 2003, the contents of which are incorporated herein.

### BACKGROUND OF THE INVENTION

1. Technical Field

The invention relates to separating particles having different specific gravities from each other without the use of water, and in particular for separating clean coal from raw coal after it has been removed from a mine by creating a fluidized bed of magnetic particles which separates the clean coal from the debris.

2. Background Information

Coal is mined from the earth by various methods such as by strip mining, deep shaft mining, and augering or side hill mining. The coal, when removed by any type of mining, usually will contain the desired clean coal, together with a mixture of debris such as dirt, shale, and other materials which surrounds the clean coal seam. This raw coal is transferred by truck, barge, conveyor, or other means to a cleaning plant which separates the clean coal from the debris. The debris then has to be returned by some type of transportation to a disposal site. The clean coal is usually separated from the debris by the use of water which floats the lighter clean coal particles from the heavier debris. However, after removal of the clean coal from the debris, the coal must be dried since it absorbed moisture from the separating water.

All of these operations, including the transportation of the raw coal to a cleaning plant, and subsequent return of the debris to a disposal site, and removal of the acquired moisture from the clean coal, and disposal of the cleaning water in settling ponds, etc., increases the cost of producing the final desired clean coal relatively free of additional moisture.

Furthermore, these coal cleaning plants usually are located at a site a considerable distance from the mine due to the size and complexity thereof and the need for the water supply.

In addition to separating clean coal from raw coal, it is desirous to separate other materials from each other, wherein the materials have different specific gravities, without the use of water to avoid the additional expense of supplying the water, removing and properly disposing of the spent water, and possibly adding unwanted moisture to one or both of the materials.

Therefore, the need exists for an improved method, apparatus, and system for separating materials without the use of water and in particular, for the cleaning of raw coal, in which the apparatus can be located generally adjacent the mining site and which enables the clean coal to be separated from the debris.

### BRIEF SUMMARY OF THE INVENTION

The invention provides a system comprised of a plurality of components which can be transported and assembled adjacent the site where the material to be separated is located, such as a coal mining site, for separating the materials, such as clean coal from the raw coal without the use of water, and which avoids transporting the raw coal a considerable distance to a coal cleaning site and the subsequent transportation of the debris back to the mine area or another site for disposal.

The invention provides a method and system which uses magnetic particles, preferably magnetite, which forms a fluidized bed within a vibratory separator whereby the lighter clean coal floats to the top of the fluidized bed where it is separated by a separator plate into a separate area for collection and transport to its final destination. Furthermore, the magnetic particles and debris are removed from the vibratory separator and passed through a magnetic separator which separates the debris from the magnetic particles, with the magnetic particles being returned for reuse with another batch of raw coal, eliminating any disposal or re-supplying of the magnetic particles as occurs when water is used as the separating and cleaning medium.

Another advantage of the present invention is that the magnetic separator is a simple and effective device, which includes a rotating drum formed of a material not readily magnetized, such as stainless steel, with an internal magnet extending about only a portion of the drum, which provides a magnetic field which separates the magnetic particles from the debris.

The invention also provides for separating materials having different specific gravities from each other in a unique mechanical vibratory separator by the use of spherical particles which form a fluidized bed which floats the lighter particles to an upper level for subsequent removal from the separator.

These features and advantages are obtained by the unique system, method, and apparatus of the present invention which includes the unique magnetic separator described further below.

### BRIEF DESCRIPTION OF THE DRAWINGS

A preferred embodiment of the invention, illustrative of the best mode in which applicant contemplates applying the principles, is set forth in the following description and is shown in the drawings and is particularly and distinctly pointed out and set forth in the appended claims.

FIG. 1 is a diagrammatic elevational view of the apparatus which forms the system located adjacent a high wall mining site;

FIG. 2 is an enlarged end elevational view of the apparatus of FIG. 1;

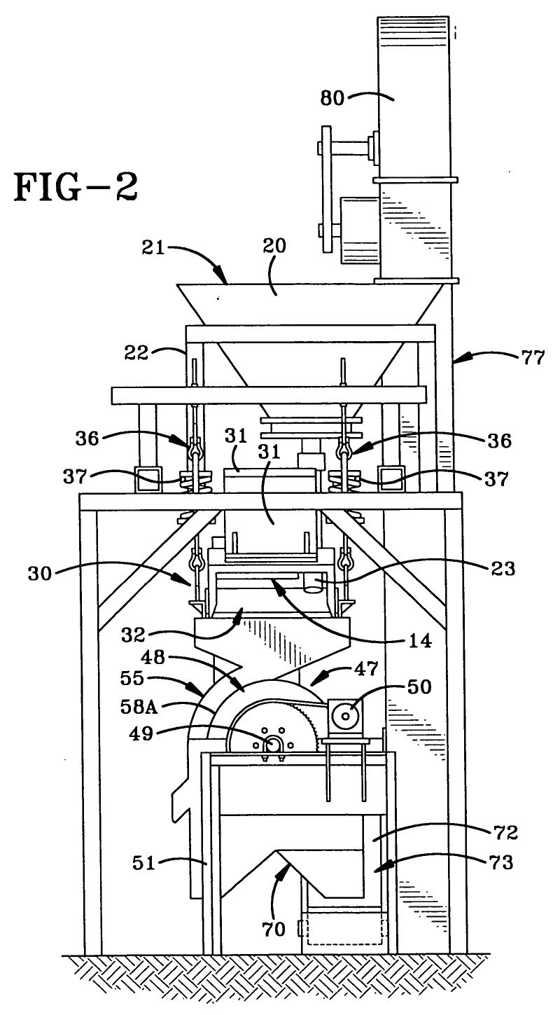

FIG. 3 is a diagrammatic elevational view with portions in section, showing the raw coal moving through a storage hopper onto a conveyor;

FIG. 4 is a diagrammatic view with portions in section, showing the supply of magnetic particles being mixed with the raw coal in the vibratory separator with the clean coal being separated and removed therefrom;

FIG. 5 is a diagrammatic elevational view with portions in section, showing the clean coal and mixture of magnetic particles and debris moving along and through the magnetic separator;

FIG. 6 is a diagrammatic sectional view taken on line 6-6, FIG. 5;

FIG. 6A is a diagrammatic sectional view taken on line 6A-6A, FIG. 5;

FIG. 7 is a diagrammatic view with portions in section, showing the magnetic particles which have been removed from the debris and cleaned coal being deposited on a conveyor;

FIG. 8 is a diagrammatic sectional view showing the magnetic particles being deposited from the belt conveyor of FIG. 7 into a bucket conveyor; and

FIG. 9 is a fragmentary view with portions in section, showing the magnetic particles in the bucket conveyor being deposited back into the supply of magnetic particles for subsequent mixture with a batch of raw coal.

Similar numerals refer to similar parts throughout the drawings.

### DETAILED DESCRIPTION OF THE INVENTION

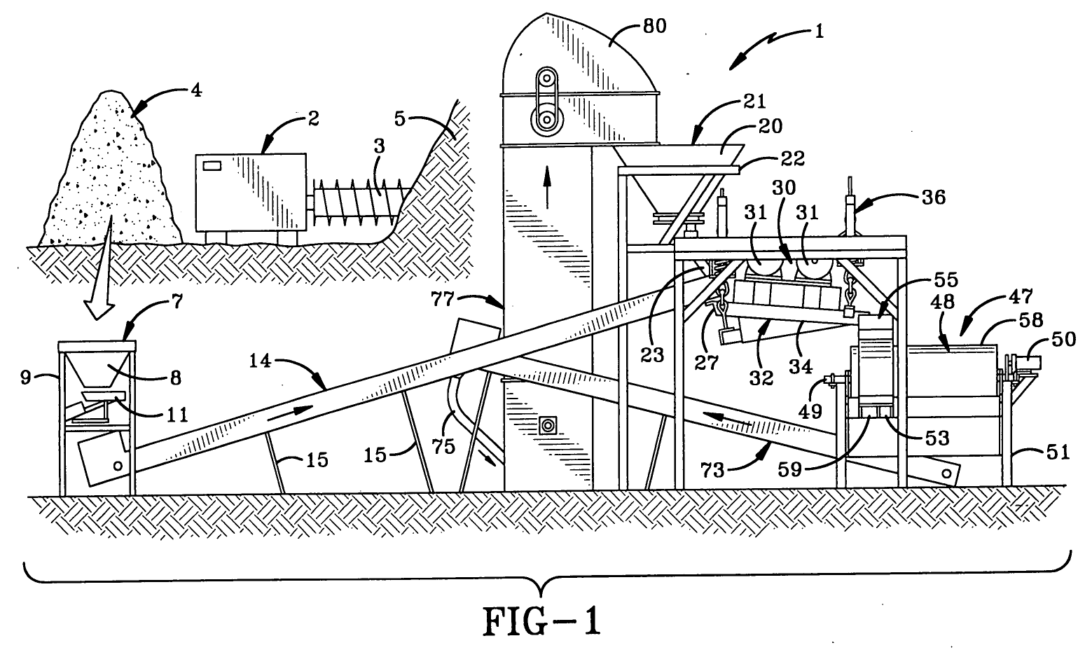

The improved system and apparatus of the present invention for carrying out the method steps is shown diagrammatically in FIG. 1 and is indicated generally at 1.

Although the system and apparatus is shown and described for separating clean coal from raw coal, but need not be limited to such a use as described further below.

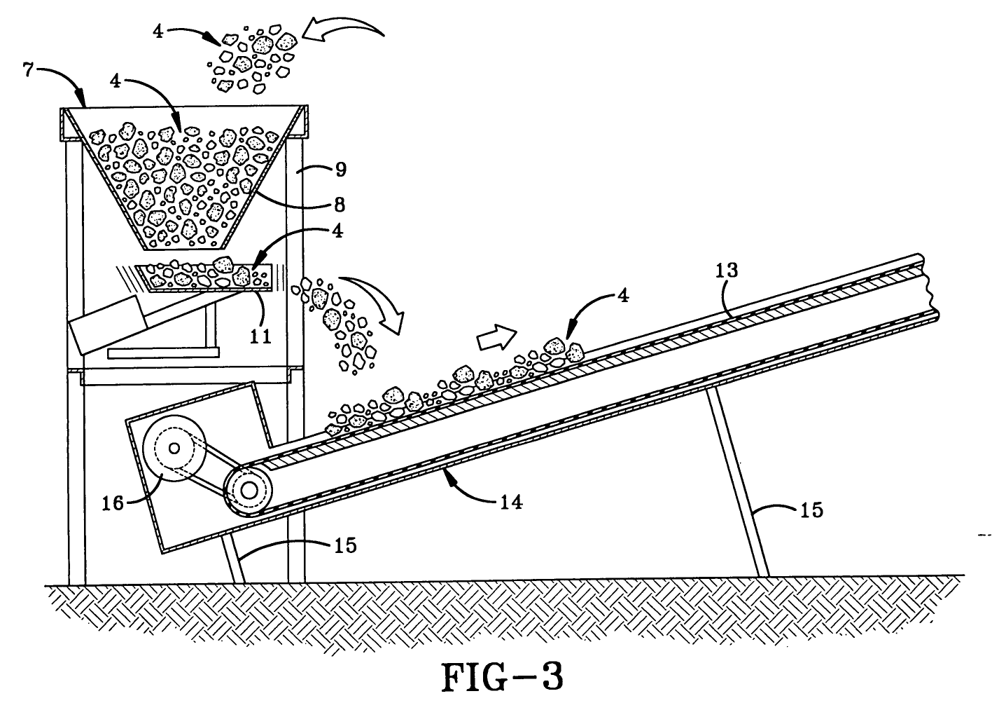

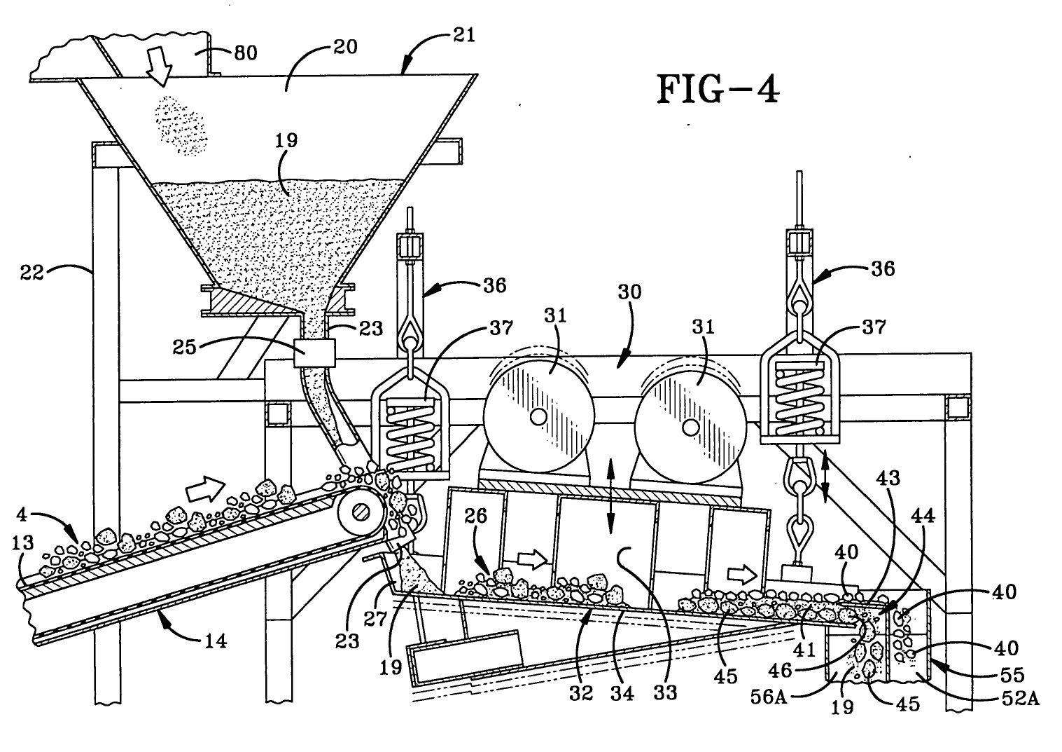

The apparatus of the preferred embodiment preferably is located adjacent a high wall mining site wherein a hillside mining auger system 2 using an auger 3 obtains a supply of raw coal 4 from a mining site 5. The batch of raw coal 4 which includes the desired clean coal and unwanted debris is fed into a hopper 7 (FIG. 3). Hopper 7 is of a usual construction containing a tapered receiving bin 8 supported on an upstanding frame 9. The raw coal is discharged from bin 8 onto a vibratory feeder 11 wherein the raw coal is measured and deposited onto a belt 13 of an inclined conveyor 14. Conveyor 14 is of a conventional construction, and includes belt 13 supported by a frame 15 with a power drive mechanism 16. The supply of raw coal 4, as shown in FIG. 3, is moved by conveyor belt 13 toward a unique mechanical separator indicated generally at 30 (FIG. 4) where it is mixed with a quantity of magnetic particles 19, a supply of which is contained in a storage bin 20 of another hopper indicated generally at 21. Hopper 21 is also of a usual construction, having the tapered storage bin 20 which is supported on an upstanding frame 22. The magnetic particles are fed by gravity through a delivery chute 23 in predetermined quantities by use of a metering valve 25 for subsequent mixing with raw coal 4 adjacent the discharge end of conveyor 14 at inlet end 27 of a separator 30.

The mixture of raw coal 4 and magnetic particles 19 indicated at 26 (FIG. 4) then moves through separator 30. Separator 30 is a mechanical vibratory separator consisting of a pair of rotary electric vibrators 31 which are mounted on a shaker table indicated generally at 32. Shaker table 32 has an outer housing 35 which provides an interior chamber 33. In accordance with one of the features of the invention, the bottom floor 34 of table 32, which heretofore was perforated to permit certain size particles to pass through for collection, is replaced with a substantially solid (non-perforated) lower inclined plate or floor 34 onto which mixture 26 is deposited. Separator 30 preferably is mounted by a pair of spaced support assemblies 36 which include spring suspensions 37 which are attached to opposite ends of separator 30. Many features of vibratory separator 30 are well known in the art and may be of the type sold and distributed by The Cleveland Vibratory Company, referred to as a RE/RES Vibrator, with shaker table 32 being a dual counter rotating model RE-124. However, these mechanical separators use a perforated bottom or separation plate for separation of different size materials/particles from each other.

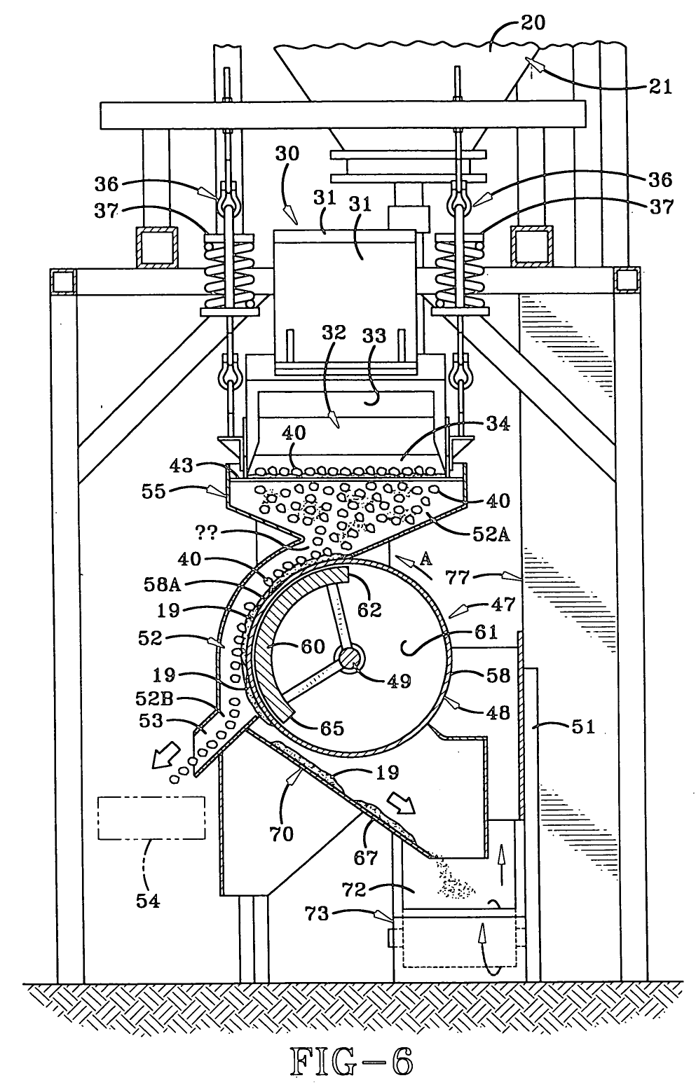

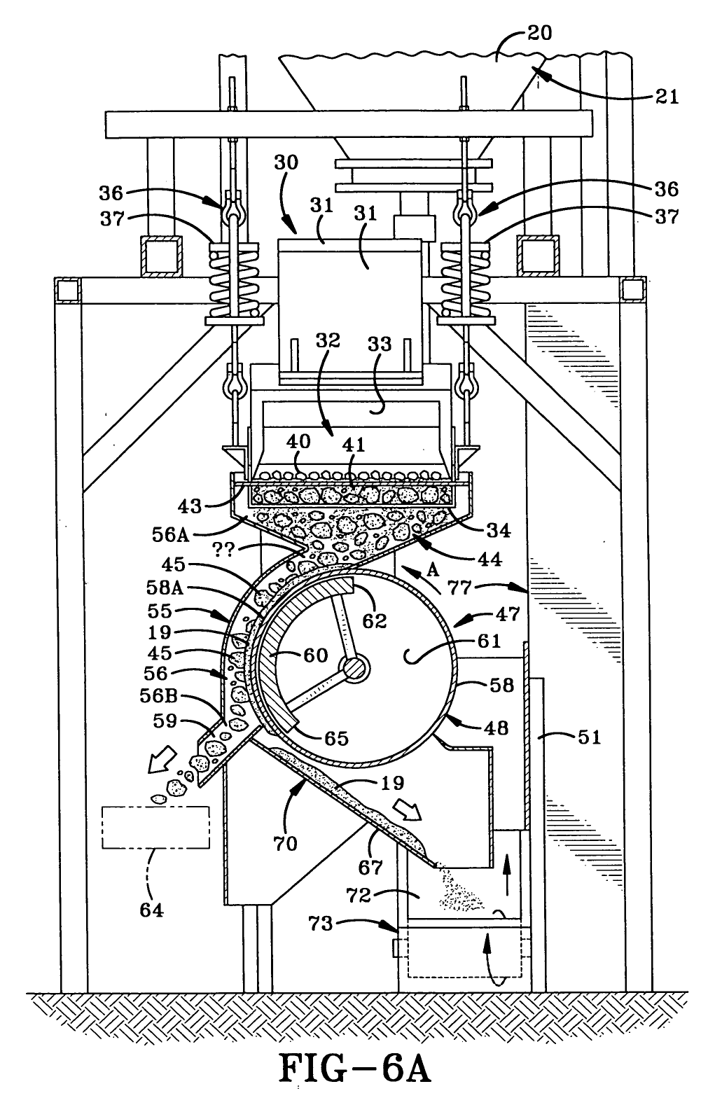

In accordance with one of the features of the invention, as mixture 26 moves along inclined vibrating table 34, the lighter weight clean coal 40 is suspended in a fluidized bed 41 created by magnetic particles 19 and moved along chamber 33 until the clean coal is removed from separator 30 by a scraper plate 43 (FIG. 6). The particles or lumps of clean coal 40 are lighter than that of the remaining debris 45, and thus as they move along fluidized bed 41 created by magnetic particles 19, they will move or float toward the top of the fluidized bed where they are easily separated by scraper plate 43 and drop from separator 30 into a tapered entrance 52A of a chute 52. Debris 45 and magnetic particles 19 form a resulting mixture 44 which drops from vibratory separator 30 and into a tapered entrance 56A of a chute 56 located beneath scraper plate 43 (FIG. 6A). A smaller quantity of magnetic particles 19 may remain with the clean coal as it drops from separator 30 into chute 52.

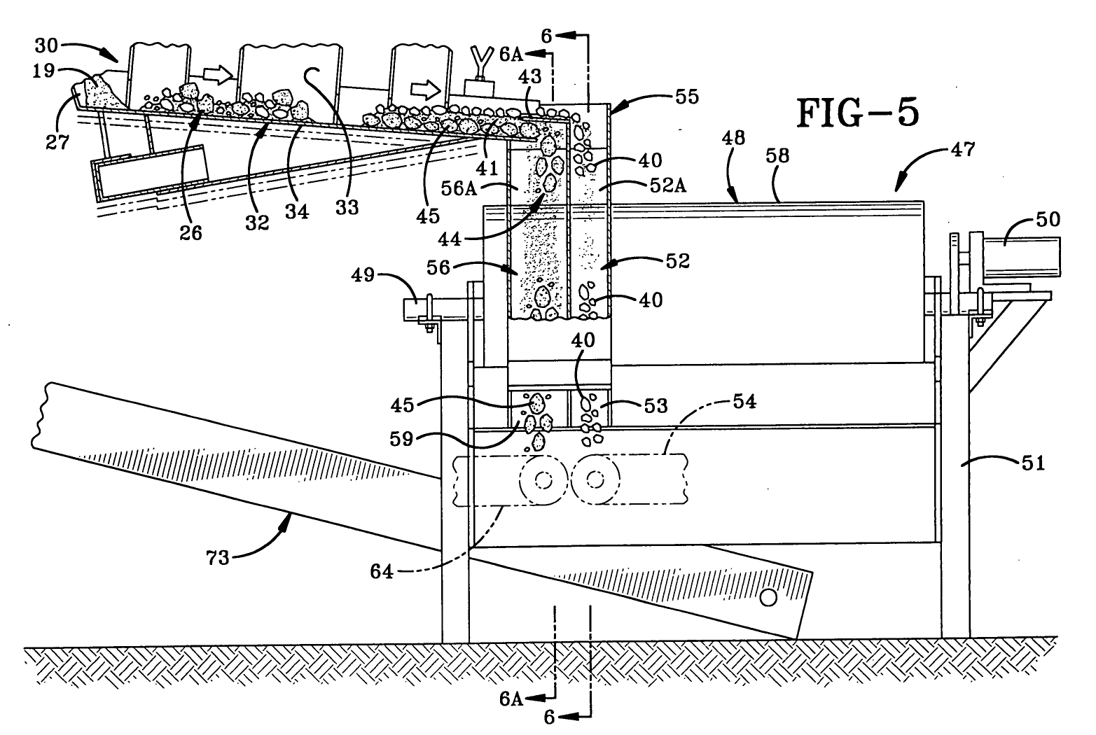

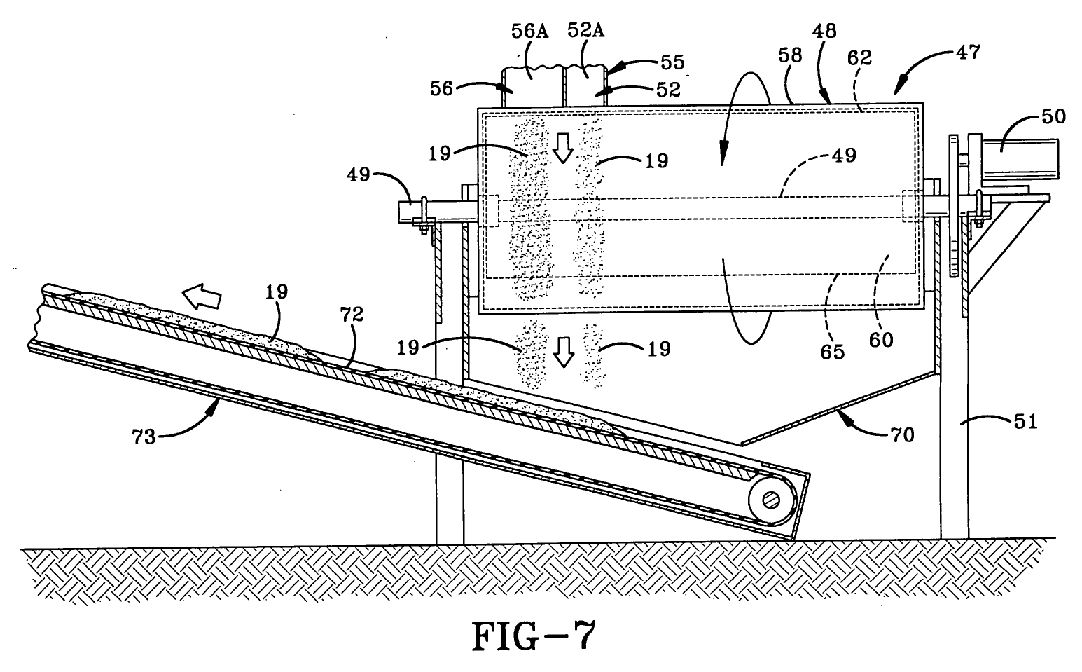

As shown in FIGS. 5, 6, 6A, and 7, the separated clean coal 40 including small amounts of magnetic particles 19, and mixture 44 of debris and magnetic particles, move through and past a magnetic separator indicated generally at 47, through chutes 52 and 56, respectively. Magnetic separator 47 includes a rotating drum 48 which is rotated about a central axis or shaft 49 by an electric motor 50, or other power drive means. Drum 48 is formed of a material that is not magnetized when in close proximity to a magnet, such as stainless steel, aluminum, etc. Separator 47 preferably is mounted on an upstanding frame 51 and includes an arcuate-shaped housing indicated generally at 55, which extends along a portion of drum 48 and forms inner chutes 52 and 56, and their respective tapered entrances 52A and 56A.

In accordance with another feature of the invention, arcuate housing 55 extends about a portion of drum 48 (FIGS. 5, 6, and 6A) and forms an outer enclosure for clean coal 40, debris 45, and magnetic particles 19. Housing 55 is formed with an open inner side 57 so that mixture 44, clean coal 40 and any entrained magnetic particles when moving through chutes 56 and 52, comes into close contact with an adjacent arcuate portion 58A of outer surface 58 of drum 48.

An arcuate-shaped magnet 60, which can be a permanent magnet, electromagnet, or other source of magnetism, is mounted in a fixed position within hollow interior 61 of drum 48 and extends along arcuate portion 58A of the drum. Magnet 60 preferably has an arcuate length less than 180° and has an upper end 62 located adjacent discharge ends 53A and 59A of tapered entrances 52A and 56A of chutes 52 and 56, as shown in FIGS. 6 and 6A. As mixture 44 and the clean coal and any accompanying magnetic particles are discharged from vibratory separator 30 along chutes 52 and 56, the materials come into close contact with outer drum surface 58 as it revolves in a counterclockwise direction as shown by arrow A, FIGS. 6 and 6A. As coal 40, debris 45, and magnetic particles 19 move along drum surface 58 through chutes 52 and 56, the magnetic particles are attracted toward magnet 60 and will collect along that portion of outer drum surface 58 which is presently adjacent magnet 60 due to the magnetic field created thereby, and the attraction of the magnetic particles toward the magnet. The attracted particles are carried along by the rotating drum until they pass beyond magnet end 65 and entrances 52B and 56B of discharge chutes 53 and 56, respectively. Chutes 53 and 56 extend outwardly from arcuate housing 55 and communicate with arcuate chutes 52 and 56, respectively. The magnetic particles 19 will fall off the drum surface by gravity since they are beyond end 65 of magnet 60, and onto a sloped wall 67 of a magnetic particle discharge chute 70, and onto a belt 72 of an inclined conveyor 73. Discharge chute 70 is common to both chutes 52 and 56 and will receive the discharged magnetic particles from both chutes. The clean coal and debris, which is not attracted toward magnet 60, will start to move away from the drum surface, as shown in FIGS. 6 and 6A, respectively, as the drum continues to revolve and will drop into discharge chutes 53 and 59 and onto conveyors 54 and 64, respectively, for transportation to their desired destination.

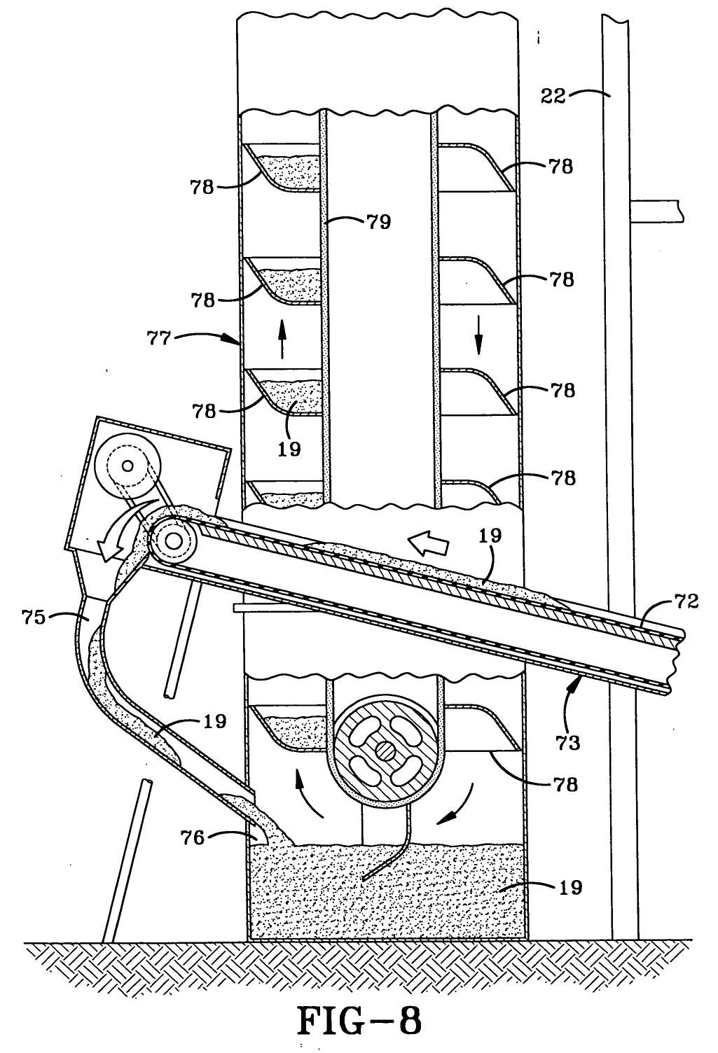

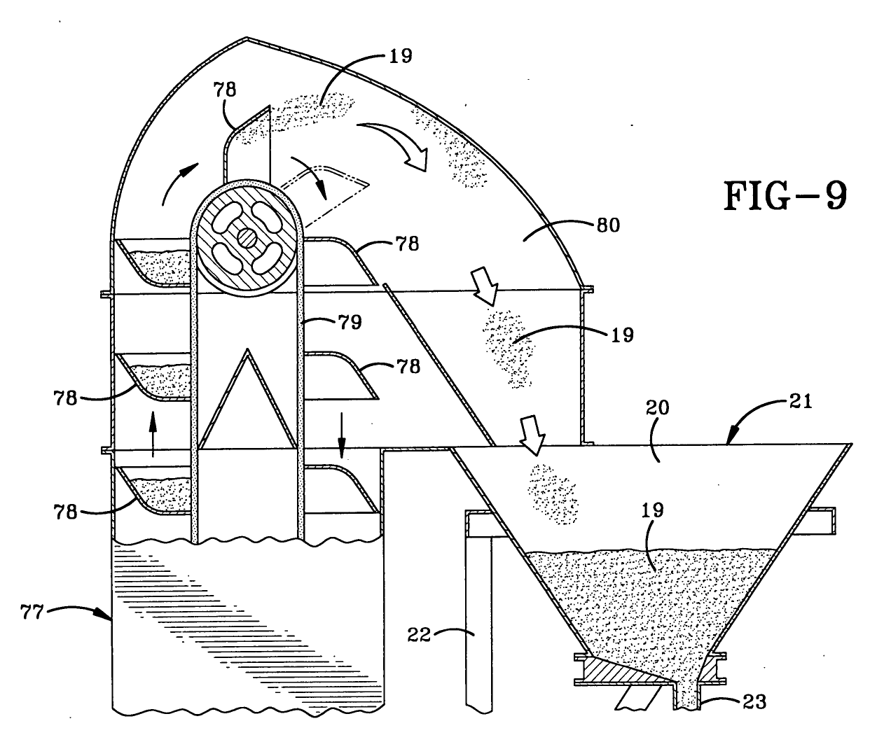

In accordance with another feature of the invention, the reclaimed magnetic particles 19 which are discharged from chute 70 onto belt 72 of conveyor 73 are delivered by belt 72 and deposited into a storage area 76 of a bucket conveyor assembly 77 (FIG. 8). Conveyor assembly 77 is of a usual construction and consists of a plurality of buckets 78 which are attached to vertically moving belts 79, chains, etc. which raise the buckets to the top of conveyor assembly 77. The magnetic particles picked up by buckets 76 are deposited back into hopper 21 by a chute 80 (FIG. 9) where the particles are mixed with the magnetic particle supply contained in storage bin 20 for subsequent reuse for mixing with another incoming batch of raw coal 4.

As shown in FIG. 1, the apparatus for assembling system 1 is comprised mainly of readily available pieces of equipment, such as storage hoppers 7 and 21 and belt conveyors 14, 54, 64, and 73, including bucket conveyor 77. Likewise, portions of vibratory separator 30 are readily available pieces of equipment, and which when assembled with solid bottom wall or plate 34 amd unique magnetic separator 47, provides a system which can be transported and erected adjacent a mining site for receiving raw coal 4 directly from the mine, whether it be a strip mine, deep mine, or side hill mining operation. Likewise, collected debris 45 can be returned easily and economically by conveyor 64 to a permanent storage area usually located adjacent to or at the mining site. Again, the portability and convenience of this apparatus enables it to be located closely adjacent the mine, thus avoiding the transportation of the raw coal to a cleaning plant and subsequent return of the debris to a permanent storage site. Furthermore, this cleaning system and apparatus does not require the availability of water and associated dryers heretofore required for the separation of the clean coal from the debris by the use of water, and avoids the subsequent removal of the moisture trapped in the retrieved clean coal. It is readily understood that other types of conveyors and storage bins can be used.

One of the important features of the preferred embodiment when cleaning raw coal is the creation of the fluidized bed within the vibratory separator, preferably by the use of magnetic particles and the ability to retrieve the magnetic particles from the debris and clean coal by magnetic separator 47 for subsequent reuse.

The magnetic particles found to be most suitable to achieve the desired fluidized bed and subsequent recapture by magnetic separator 47 is magnetite. Also, the particular magnetite found preferable is a type produced by a chemical reaction utilizing gaseous oxygen which transfers iron-units (whether from waste-streams or purchased raw materials) into iron oxide spherical pellets, such as produced by Pel Technology under the trademark magPAL®. The atomized magnetite spheres preferably are in the general size range of 150-500 microns. However, it is readily understood that other types of particles could be utilized for achieving the features of the present invention.

Magnetic separator 47 enables magnetic particles 19 to be easily separated from the debris and clean coal due to the magnetic attraction toward magnet 60, after which they drop off the temporarily magnetized portion of outer surface 58 of revolving drum 48 when it revolves beyond end 65 of magnet 60. This provides a considerable cost savings by capturing nearly all of the magnetic particles which are then returned by an appropriate conveyor system back into storage bin 20 of hopper 21. Vibratory feeder 11 and metering valve 25 insures that the correct amount of magnetic particles are combined with the correct amount of raw coal to form mixture 26 in chamber 33 of vibratory separator 30 to achieve maximum separation of clean coal 40 from the raw coal, with the remaining mixture 44 of debris 45 and magnetic particles 19 being further processed by magnetic separator 47. The particular ratios will depend upon the density and size of magnetic particles 19, the particular debris being discharged from a particular mine, together with the size and force exerted by electric vibrators 31 and the slope of shaker plate or floor 34. These various factors control the amount of raw coal and magnetic particles to be joined to form mixture 26 upon entering vibratory separator 30.

Furthermore, changing the frequency of the vibration imparted on outer housing 35 and the angle of inclination of bottom plate 34 of vibratory separator 30, will effect the formation of fluidized bed 41, which in turn, effects the separation of the various particles passing through chamber 33. Thus, tuning this frequency and pitch to the particular characteristics of the raw coal entering chamber 33 will increase the effectiveness of separating the clean coal from the debris.

The specific gravities of the clean coal and debris will vary between mining sites as well as in certain locations within a particular mine. Thus, the most efficient separation can be achieved by proper tuning of separator 30, depending upon the particular characteristics of the raw coal.

It is readily understood that other materials than coal can be separated from a mixture without the use of water by the system and apparatus of the present invention. For example, other types of materials than magnetite can be used, such as spherical balls of steel, ceramics, etc. These materials will form a fluidized bed which will then separate two materials having specific gravities different from each other. The size and type of materials forming the fluidized bed will vary depending upon the makeup of the materials being separated. The fluidized bed material need not be a readily magnetized material as is the magnetite, so long as it is able to form the fluidized bed when vibrated, for separating materials having different specific gravities. The fluidized bed is tuned to the particular materials being separated so the lighter particles float to the top of the fluidized bed for removal by scraper plate 43 or other mechanism. Magnetic material, such as magnetite, is preferred since it facilitates the recapture from the debris or other mixture component for reuse. Tuning of the fluidized bed will determine its thickness, density, location, etc., to achieve maximum separation of the materials, depending upon the particular materials being separated.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A system for cleaning raw coal including:
a supply of raw coal containing clean coal and debris;
a supply of magnetic particles;
a vibratory separator for receiving a quantity of the raw coal and a quantity of the magnetic particles, said magnetic particles creating a fluidized bed which separates the clean coal from the debris, and for discharging the clean coal from the vibratory separator separately from a remaining mixture of the magnetic particles and debris; and
a magnetic separator for receiving the mixture of magnetic particles and debris from the vibratory separator and separating the magnetic particles from the debris.

2. The system defined in claim 1 wherein the supplies of raw coal and magnetic particles are stored in first and second hoppers, respectively.

3. The system defined in claim 2 including a conveyor for transporting the raw coal from the first hopper to the vibratory separator.

4. The system defined in claim 1 including a chute for removing the magnetic particles from the magnetic separator and a conveyor for returning the separated magnetic particles removed from the magnetic separator back into the supply of magnetic particles.

5. The system defined in claim 4 wherein the conveyor includes a section of a belt conveyor and a section of a bucket conveyor.

6. The system defined in claim 1 wherein the vibratory separator includes at least one rotary vibrator, a separating chamber and a scraper plate.

7. The system defined in claim 6 wherein the separating chamber includes an inlet for receiving a quantity of the raw coal and magnetic particles, and an outlet; and in which the scraper plate is located adjacent the outlet and is in communication with first and second discharge ducts located at said outlet, and wherein said first duct receives the mixture of magnetic particles and debris and the second duct receives the clean coal.

8. The system defined in claim 7 wherein the first and second ducts have an open side which communicates with the magnetic separator.

9. The system defined in claim 1 wherein the magnetic separator includes a rotating drum having a generally non-magnetic outer surface and a magnet located within the drum and extending along only a portion of the drum.

10. A method of cleaning raw coal including the steps of:
mixing a quantity of raw coal containing clean coal and debris with a quantity of magnetic particles;
feeding the mixture of magnetic particles and raw coal into a vibratory separator with the magnetic particles creating a fluidized bed to separate clean coal from the debris; and
removing the clean coal from the vibratory separator.

11. The method defined in claim 10 including the further step of removing the magnetic particles and debris from the vibratory separator and feeding the magnetic particles and debris into a magnetic separator; and separating the magnetic particles from the debris in said magnetic separator.

12. The method defined in claim 11 including the step of removing the magnetic particles from the magnetic separator; and returning the separated magnetic particles to a supply of magnetic particles for subsequent mixing with the raw coal.

13. The method defined in claim 12 including the step of storing a supply of the magnetic particles in a hopper; and providing a conveyor for returning the separated magnetic particles from the magnetic separator into the supply of magnetic particles.

14. The method defined in claim 11 wherein the step of separating the magnetic particles from the debris further includes the steps of providing a rotating drum having a non-magnetic outer surface; providing a magnetic field adjacent a portion of said drum surface; moving the stream of debris and magnetic particles through the magnetic field as the drum rotates whereby the magnetic particles are attached by the magnetic field and separate from the debris and temporarily adhere to a portion of the drum's outer surface adjacent the magnetic field; and
moving the said portion of the drum outer surface past the magnetic field to remove the adhered magnetic particles therefrom.

15. Apparatus for erection at a coal mining site to separate clean coal from raw coal containing the clean coal and debris without the use of water, said apparatus comprising:
a first hopper for receiving a supply of the raw coal;
a second hopper for receiving a supply of magnetic particles;
a mechanical separator for receiving predetermined quantities of the raw coal and magnetic particles and for creating a fluidized bed from the magnetic particles to separate the clean coal from the magnetic particles and debris;
a first conveyor for delivering a supply of the raw coal to the mechanical separator;
a magnetic separator for receiving the magnetic particles and debris from the mechanical separator, and for separating the magnetic particles from the debris; and
a second conveyor for delivering the magnetic particles separated in the magnetic separator back into the second hopper.

16. The apparatus defined in claim 15 wherein the mechanical separator is a vibratory separator including a rotary vibrator, a shaker table for receiving the raw coal and magnetic particles for creating the fluidized bed of magnetic particles to separate the clean coal from the debris; and a scraping plate for removing the clean coal from the magnetic particles and debris.

17. The apparatus defined in claim 15 wherein the magnetic separator includes a rotating drum having a non-magnetic outer surface and a magnet located within the drum and extending along only a portion of the drum outer surface.

18. The apparatus defined in claim 15 wherein the magnetic particles are magnetic.

19. The apparatus defined in claim 18 wherein the magnetic particles are substantially spherical having a size in the general range of between 150 and 500 microns.

20. A magnetic separator for separating magnetic particles from debris including a rotating drum having a non-magnetic outer surface; a magnet located within the drum and extending along a portion of the drum to provide a magnetic field adjacent said portion of the drum; a duct for directing the magnetic particles and debris along the said portion of the drum whereby said magnetic particles are attached toward the magnet and temporarily adhere to the said portion of the drum adjacent the magnet; and a collector located adjacent the drum for collecting the magnetic particles as the said portion of the drum rotates beyond the magnet.

21. The magnetic separator defined in claim 20 wherein the magnet is an arcuate-shaped permanent magnet mounted in a fixed position within the rotating drum.

22. The magnetic separator defined in claim 21 wherein the magnet extends through an arc of less than 180°.

23. The magnetic separator defined in claim 20 wherein the duct has an upper inlet for receiving the magnetic particles and debris and a lower outlet to remove the debris by gravity from the magnetic separator.

24. A vibratory separator for separating two materials having different specific gravities from a mixture of said materials including:
a chamber having an inclined substantially non-perforated plate for receiving a quantity of said mixture;
a supply of particles capable of forming a fluidized bed when subjected to vibration in the chamber;
a vibrator for vibrating the inclined plate to create a fluidized bed of the particles within the chamber whereby the lighter of said two materials floats on the fluidized bed; and
a divider for removing the lighter material from the chamber as the fluidized bed and materials move along the inclined plate.

25. The vibratory separator defined in claim 24 wherein the divider is a scraper plate positioned adjacent a discharge opening of the chamber.

26. The vibratory separator defined in claim 24 wherein the inclined plate is located within an outer housing; in which the vibrator is a rotary electric vibrator mounted on said housing; and in which the housing is supported by resilient members.

27. A method for separating two materials having different specific gravities from a mixture of said material without the addition of water, including the steps of:
mixing a quantity of the mixture with a quantity of dry particles capable of forming a fluidized bed when vibrated;
feeding the mixture and particles into a vibratory separator with the particles creating a fluidized bed to separate the two materials; and
removing the material with the lower specific gravity from above the fluidized bed and from the vibratory separator.

28. The method defined in claim 27 including the step of feeding the material with the higher specific gravity and particles into a second separator for removing the particles from said higher specific gravity material.

29. The method defined in claim 28 including the steps of forming the particles of a magnetic material; providing the second vibrator with a magnetic field; and
attracting the magnetic particles toward the magnetic field to remove said particles from the material having the higher specific gravity.

30. The method defined in claim 29 including the steps of removing the magnetic particles from the second vibrator for subsequent mixing with another quantity of the material mixture.
